(19) United States
(12) Patent Application Publication
(10) Pub. No.: US 2017/0318638 A1
(43) Pub. Date: Nov. 2, 2017

(54) DRIVER DEVICE AND DRIVING METHOD FOR DRIVING A LOAD

(71) Applicant: PHILIPS LIGHTING HOLDING B.V., EINDHOVEN (NL)

(72) Inventor: ERIC JOHANNUS HENRICUS CORNELIS MARIA NIEUWLANDS, EINDHOVEN (NL)

(73) Assignee: Philips Lighting Holding B.V., Eindhoven (NL)

(21) Appl. No.: 15/524,241

(22) PCT Filed: Nov. 4, 2015
(86) PCT No.: PCT/EP2015/075720

§ 371 Date: May 3, 2017

(30) Foreign Application Priority Data
Nov. 7, 2014 (EP) 14192188.2

(51) Int. Cl. H05B 33/08; H05B 37/02

(52) U.S. Cl. CPC H05B 33/0845; H05B 33/0809; H05B 37/0272

(57) ABSTRACT

A driver device (24) for driving a load (18), in particular a light unit comprising one or more LED's is presented. The driver device comprises input terminals (20, 22) for connecting the driver device to an external electrical power supply (12) and for receiving an input voltage (V10). The driver device further comprises a power converter unit (26) connected to the input terminals for converting the input voltage to a drive voltage (V20) and/or a drive current (120) for powering the load and a control unit (28) connected to the power converter unit for controlling an electrical power provided by the power converter unit to the load. An input device (30) is connected to the control unit for setting a power level of the electrical power provided by the power converter unit to the load, and a memory device (36) is associated to the control unit, wherein the control unit is adapted to determine a level of the electrical power that can be drawn from the input terminals and to store the determined level of the electrical power in the memory device.

### FIELD OF THE INVENTION

The present invention relates to a driver device and a corresponding driving method for driving a load, in particular for driving a light unit comprising one or more LEDs. The present invention further relates to a lighting apparatus comprising a light unit having one more LEDs and a driver device for driving the light unit.

### BACKGROUND OF THE INVENTION

In the field of LED drivers for offline applications or retrofit applications, solutions are demanded to drive the retrofit LEDs reliable over a large power range, wherein the light emission can be set to a desired value without power drop independently of the electrical power source and the driver device to which the LEDs are connected.

After retrofit replacement of an existing lamp by a different type of lamp that has improved properties regarding e.g. power consumption, light output or costs, the existing driver of the replaced lamp, e.g. a fluorescent tube or a discharge lamp has to cope with the electrical power consumption of the new lamp, which may lead to a reset of the existing driver or a power drop or cut at certain power levels so that a dimming over the whole power range cannot be achieved in each retrofit situation.

From U.S. 2014/0252992 A1 a system for controlling the dimming of a solid state lighting device is known, wherein the light emission of a solid state lighting unit is controlled on the basis of the dimming level provided by a dimmer, so that the light output is set to a desired level. The disadvantage of this system is that a reliable functionality for a retrofit application cannot be achieved if the dimming level is reduced to a power level which cannot be driven by the present driver of the replaced lamp.

### SUMMARY OF THE INVENTION

It is an object of the present invention to provide an improved driver device for driving a load which provides a reliable functionality and a reliable light output in combination with an external power source. It is a further object of the present invention to provide a corresponding driving method for driving a load and a corresponding light apparatus.

According to one aspect of the present invention, a driver device is provided for driving a load, in particular a light unit comprising one or more LEDs, comprising:
input terminals for connecting the driver device to an external electrical power supply and for receiving an input voltage,
   a power converter unit connected to the input terminals for converting the input voltage to a drive voltage and/or a drive current for powering the load,
   a control unit connected to the power converter unit for controlling an electrical power provided by the power converter unit to the load,
   an input device connected to the control unit for setting a power level of the electrical power provided by the power converter unit to the load, and
   a memory device associated to the control unit, wherein the control unit is adapted to determine a level of the electrical power that can be drawn from the input terminals and to store the determined level of the electrical power in the memory device.

According to another aspect of the present invention, a driving method is provided for driving a load, in particular a lighting device comprising one or more LEDs, comprising the steps of:
receiving an input voltage from an external electrical power supply at input terminals,
   converting the input voltage by means of a power converter unit to a drive voltage and/or a drive current for powering the load,
   controlling an electrical power level provided by the power converter unit to the load,
   determining a level of the electrical power that can be drawn from the input terminals, and
   storing the determined level of the electrical power in a memory device.

According to a further aspect a lighting apparatus is provided comprising a light unit having one or more LEDs, a driver unit for providing electrical power, wherein the driver unit is adapted to drive a lighting device, and a driver device according to the present invention for driving the light unit, wherein the driver device is connected to the driver unit for receiving electrical power.

Preferred embodiments of the invention are defined in the dependent claims. It shall be understood that the claimed method has similar and/or identical preferred embodiments as the claimed device and as defined in the dependent claims.

The present invention is based on the idea to provide a driver device for driving a load which can be connected to an external electrical power supply, e.g. as a retrofit connection to an existing driver unit, wherein the driver device comprises an input device and a power converter unit so that the electrical power provided to the load for powering the load can be set to a desired level. Since the external electrical power supply probably does not provide electrical power over the whole power range of the driver device with a high reliability, the control unit of the present driver device is adapted to determine a level of the electrical power that can be drawn via the input terminals from the external power supply and stores the so determined level of the electrical power in a memory device. On the basis of the so determined level of the electrical power that can be drawn reliable from the external power supply, a reliable functionality of the driver device and the connected load can be achieved without an undesired power drop or cut of the electrical power supply due to a power level that cannot be provided by the external electrical power supply.

In a preferred embodiment, the determined level of the electrical power is a minimum power level that can be drawn from the input terminals. This is a possibility to avoid a dimming level of the driver device that cannot be driven by the external electrical power supply so that an undesired drop or cut of the electrical power can be avoided.

In a preferred embodiment, the control unit is adapted to control the power converter unit so that the electrical power drawn from the input terminals is decreased in order to determine the minimum power level. This is a possibility to determine the minimum power level with high reliability and low technical effort, since the electrical power drawn from the input terminals is reduced until a drop or a cut of the power supply is reached.

In a preferred embodiment, the control unit is adapted to decrease the power level continuously. This is a possibility to precisely determine the minimum power level.

In a further preferred embodiment, the control unit is adapted to decrease the power level stepwise. This is a possibility to determine the minimum power level quickly with low technical effort.

In a preferred embodiment, the input device is a user input device for providing a user input signal to the control unit. This is a possibility to set the electrical power provided to the load to a user defined level.

In a further preferred embodiment, the control unit is connected to the input terminals in order to receive electrical power from the input terminals. This is a possibility to provide electrical power to the control unit and to detect a power drop or cut of the external electrical power supply with low technical effort.

In a preferred embodiment, the control unit is adapted to determine the level of the electrical power during the operation of the driver device on a regular basis. This is a possibility to consider deterioration of the external power supply and/or the power converter unit so that the level of the electrical power is precisely determined in any case.

In a preferred embodiment, the control unit is adapted to determine the level of the electrical power during power up of the driver device or after a predefined time duration. This is a possibility to determine the power level frequently on a regular basis with low technical effort.

In a preferred embodiment, the memory device is a non-volatile memory. This is a possibility to store the determined level of the electrical power for a long time, so that a power down of the driver device cannot affect the level of the electrical power stored in the memory device.

In a preferred embodiment, the control unit is adapted to control the power converter unit on the basis of the user input received from the user input device and on the basis of the determined level of the electrical power stored in the memory device. This is a possibility to set the power level provided to the load to a desired value in order to provide a certain dimming level over a power range which can be provided by the external electrical power supply with high reliability so that an undesired power drop or cut of the power supply and a corresponding malfunction of the load can be avoided.

In a preferred embodiment of the driving method it is repeatedly performed to store a level of the electrical power currently drawn from the input terminal in the memory device followed by a reduction of the level of the electrical power to determine a minimum power level as a level of the electrical power. This is a possibility to determine the minimum power level that can be provided by the external electrical power supplied precisely with low technical effort.

It is further preferred if the level of the electrical power is reduced until the electrical power drawn from the input terminals is turned off This is a possibility to determine the minimum power level with low technical effort.

In a preferred embodiment, the power level is decreased continuously or stepwise. This is a possibility to determine the minimum power level precisely or with low technical effort.

In a further preferred embodiment, the electrical power is determined during the operation on a regular basis. This is a possibility to consider deterioration of the external electrical power supply and the power converter unit since the level of the electrical power that can be drawn is frequently determined.

As mentioned above, the driver device and the driving method provides a possibility to receive electrical power from an external power supply and to determine a power level that can be provided or driven by the external power supply and to store the so determined electrical power level in the memory device so that the power range which can be provided by the external power supply can be considered during dimming and the driver device always draws an electrical power level within the functionality range of the external power supply. Hence, an undesired power drop or cut of the electrical power supply can be avoided. Hence, a reliable electrical power supply can be achieved by the driver device and the driving method for powering the load.

### BRIEF DESCRIPTION OF THE DRAWINGS

These and other aspects of the invention will be apparent from and elucidated with reference to the embodiment(s) described hereinafter. In the following drawings

FIG. 1 shows a schematic block diagram of a lighting apparatus including a retrofit lamp,

FIG. 2 shows a flow diagram of a method for driving a load, and

FIG. 3 shows a detailed block diagram of a retrofit lamp connected to a driver for providing electrical power to the retrofit lamp.

### DETAILED DESCRIPTION OF THE INVENTION

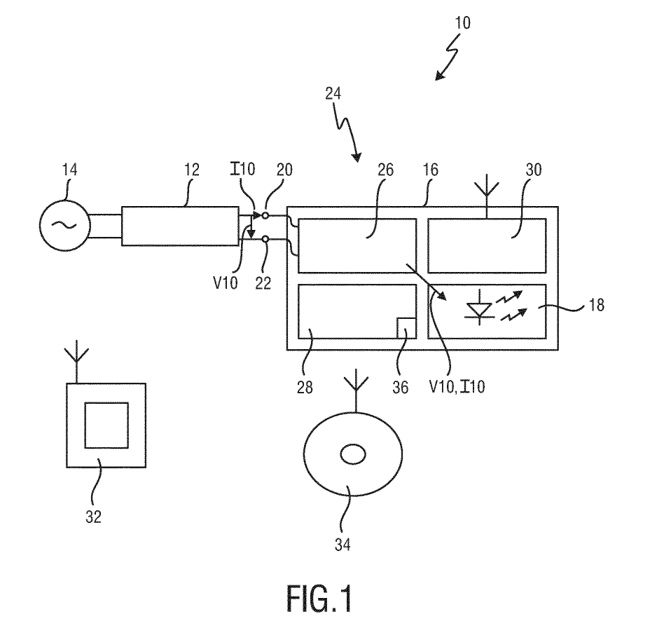

FIG. 1 shows a schematic block diagram of a lighting apparatus generally denoted by 10. The lighting apparatus 10 comprises a driver 12 or ballast 12, which is connected to an electrical power source 14 which is preferably mains. The driver 12 is adapted to provide electrical power to a load, e.g. to a fluorescent tube lamp or a high intensity discharge lamp. The load or the lamp for which the driver 12 is designed is replaced in a retrofit replacement by a light unit 16 having other properties than the replaced lamp and comprises in this particular embodiment a plurality of LEDs 18 for e.g. reducing the power consumption in general. The light unit 16 comprises input terminals 20, 22 for connecting the light unit 16 to output terminals of the driver 12 and for receiving electrical power from the driver 12.

The light unit 16 comprises in general a driver device 24, which is connected via the input terminals 20, 22 to the driver 12 and which provides a drive voltage and/or a drive current for powering the LEDs 18. The driver device 24 comprises a power converter unit 26, which is connected to the input terminals 20, 22 for converting an input voltage V10 and/or an input current 110 provided by the driver 12 to the drive voltage V20 and/or the drive current 120 which is provided to the LEDs 18 for powering the LEDs 18. The power converter unit 26 is adapted to set the drive voltage V20 and the drive current 120 to a desired value in order to set the electrical power provided to the LEDs 18 to a desired value so that a dimming of the LEDs is possible.

The driver device 24 further comprises a control unit 28, which is connected to the power converter unit 26 for controlling the power converter unit 26 and for setting a power level of the electrical power provided to the LEDs 18. The control unit 28 is electrically connected to the input terminals 20, 22 for receiving electrical power so that the control unit 28 is powered by the driver 12.

The driver device 24 further comprises an interface 30 for transmitting and receiving signals, which is in this particular case a wireless interface. The interface 30 is adapted to receive user input data from a user input terminal 32 for remote control of the lighting apparatus 10 in general. The interface 30 is further adapted receive and/or transmit control signals to or from other peripheral devices 34 like passive infrared sensors, light sensors, switches or other lamps to be controlled by the control unit 28. The interface 30 is connected to the control unit 28 in order to submit the input signals received from the user input terminal 32 or the other peripheral devices 34 to the control unit 28 and to set the electrical power provided by the power converter unit 26 to the LEDs according to the input signal or the user input. The interface 30 can further receive control signals from the control unit 28 in order to submit control signals to other light units 16 and to control other light units 16 accordingly. The interface 30 may also receive signals from the peripheral devices 34 like passive infrared sensors and light sensors or other switching devices in order to activate the light unit 16 or to set the electrical power provided to the load on the basis of the received signals. In on embodiment, the electrical power may be set on the basis of the environmental light determined by a connected light sensor 34. In an alternative embodiment, the interface 30 may comprise a button as a user input device to determine the electrical power which is provided to the LEDs 18 in order to set the light emission to a desired value.

Hence, the light unit 16 can be connected to the driver 12 in a retrofit replacement, wherein the power converter unit 26 can be individually controlled on the basis of user input signals via the interface 30 in order to provide electrical power to the LEDs 18 and to control the light emission of the LEDs 18. By means of the user input terminal 32 and the interface 30 which is in this particular case a wireless connection via infrared or radio frequency signals, the electrical power provided to the LEDs 18 can be individually set to a desired level so that a dimming of the LEDs 18 can be achieved without an amendment of the power supply formed by the electrical power source 14 and the driver 12.

Since the driver 12 is designed to drive a certain type of lamp, e.g. a fluorescent lamp or a high intensity discharge lamp, the driver 12 may not operate properly over the whole range of electrical power which can be drawn from the driver device 24. In particular, the driver 12 does usually not work properly below the certain threshold level and reduces the output voltage V10 to zero, provides a reset or provides an unstable output voltage V10 if the electrical power drawn by the connected light unit 16 drops below a certain threshold level.

To avoid an undesired drop of the electrical power supply of the driver 12 or a reset of the driver 12, the minimum level of the electrical power must not drop below a minimum threshold level of the electrical power that can be provided by the driver 12. In order to avoid a drop down of the electrical power supply, the control unit 28 comprises a memory device 36 for storing the minimum level of the electrical power which can be provided by the driver 12. The control unit 28 controls the power converter unit 26 accordingly so that the electrical power which is drawn from the driver 12 does not drop below the respective minimum level of the electrical power.

The minimum level of the electrical power is determined individually by the control unit 28 so that the light unit 16 can be utilized universally and can be connected to different drivers as a retrofit replacement of different kinds of lamps. To determine the minimum level of the electrical power that can be drawn from the driver 12, the control unit 28 stores a current value of the power level in the memory device 36 and reduces the electrical power drawn from the driver 12 by a predefined value. If the electrical power which can be drawn from the driver 12 is still stable after the reduction and no reset of the driver 12 has occurred at the lower level of the electrical power, the control unit 28 stores the new power level in the memory device 36 and reduces the electrical level again by a predefined amount in order to achieve a further lower power level. The control unit 28 repeats the reduction of the electrical power drawn from the driver 12 iteratively until the electrical power provided by the driver 12 drops down to zero or breaks up so that the light unit 16 including the control unit 28 is powered down. Since the memory device 36 is a non-volatile memory, the last power level which could be drawn from the driver 12 is still stored in the memory device 36 and can be derived from the control unit 28 in order to control the power converter unit 26 for following power ups accordingly.

The minimum level of the electrical power that can be drawn from the driver 12 is determined during the operation of the light unit 16 and is determined repeatedly on a regular basis. The minimum level can be determined at each power up of the light unit 16 or after a certain amount of power ups or after a predefined time duration so that any changes in the minimum level of the electrical power that can be drawn from the driver 12 can be determined and considered for setting the lowest possible power level of the power converter unit 26 in general.

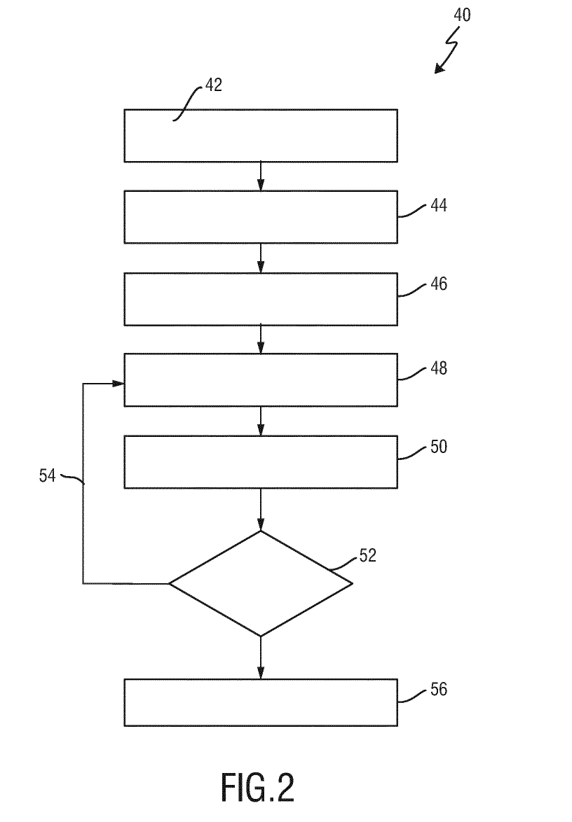

FIG. 2 shows a schematic flow diagram illustrating a method for driving the LEDs 18 which is generally denoted by 40. The method 40 starts with a triggering of the detection of the possible power range as shown at 42. In a first step, the control unit 28 stores in the memory device 36 an information that the detection of the power range is enabled as shown at step 44. The information may be a flag or a tag stored in the non-volatile memory device 36. In the following step shown at 46, the power converter unit 26 is set to a maximum power level provided to the LEDs 18 and correspondingly drawn from the driver 12. In a following step shown at 48, the power level which was set at step 46 is stored in the non-volatile memory device 36. In a following step shown at 50, the electrical power level is decreased by a predefined value and the respective power level drawn from the driver 12 is determined as shown at 52. If the level of the electrical power is above zero, the method returns to step 48 and continues with storing the current power level in the non-volatile memory device 36 indicated by the loop 54. If the electrical power level determined at step 52 is determined to be zero, the information, e.g. the flag or the tag stored in the non-volatile memory device 36 is removed as shown at step 56.

If the driver 12 is reset during the reduction of the electrical power drawn from the driver 12 or if the power supply breaks up or the electrical power becomes unstable, the control unit 28 is reset, since the electrical power supply of the control unit 28 is correspondingly switched off In that case, the last level of the electrical power which could be drawn from the driver 12 is still stored in the non-volatile memory device 36 so that this value can be derived as the minimum level of the electrical power from the non-volatile memory 36 and can be utilized for the following control of the power converter unit 26.

Further, if the tag stored in the memory device 36 is present during power up of the light unit 16, the tag indicates that the light unit 16 was reset during a previous determination of the minimum power level and the stored minimum power level is preferably increased by a predefined level in order to set the power range of the light unit 16 to a reliable level separated from or above the power cut-off level.

Consequently, the minimum level of the electrical power that can be drawn from the driver 12 can be determined precisely with low technical effort so that in the following a dimming range of the light unit 16 is defined in which the light unit 16 can be operated stable and reliable.

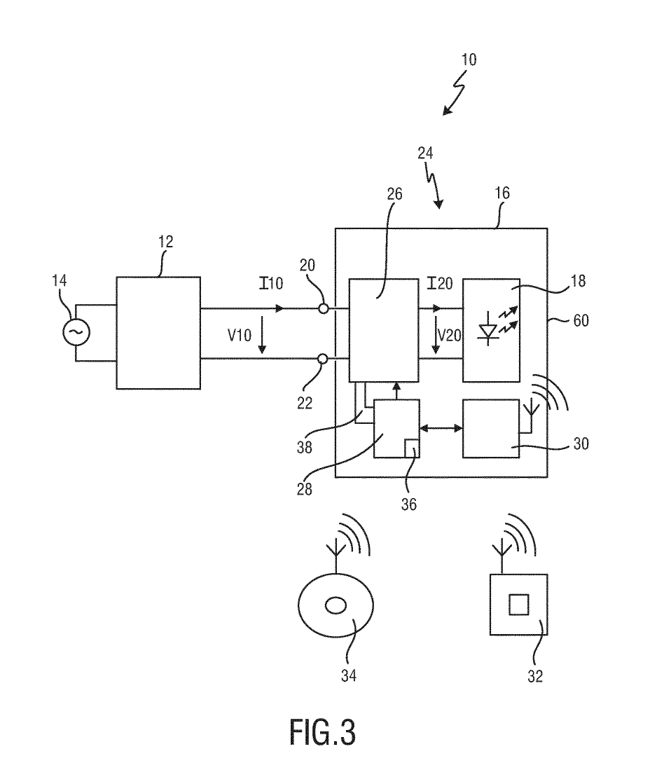

FIG. 3 shows a detailed block diagram of the lighting apparatus 10. Identical elements are denoted by identical reference numerals, wherein here merely the differences are described in detail.

The power converter unit 26 converts the input voltage V10 to the drive voltage V20 and/or the drive current 120 for powering the LEDs 18. The power converter unit 26 is controlled by the control unit 28, which is connected to the input terminal 20, 22 by means of electrical wires 38 or interconnects 38 so that the control unit 28 is electrically powered via the input terminals 20, 22 by the driver 12. The control unit 28 is connected to the interface 30, which comprises in a particular embodiment a wireless interface for transmitting and receiving signals, e.g. via radio frequency transmission or infrared transmission. The interface 30 is correspondingly connected to the user input terminal 32 and the peripheral devices 34. The user can set the dimming level of the light unit 16 via the user input terminal 32 and the control unit 28 can control the peripheral devices 34 via the interface 30. Further, via the interface 30, additional devices like passive infrared sensors or light sensors or switches can be connected to the light unit 16 so that the light unit 16 can be controlled on the basis of additional sensor information.

The driver device 24 and the LEDs 18 are disposed in a light unit case 60 which can be connected to the driver 12 via the input terminals 20, 22 and can easily replace a lamp which is usually connected to the driver 12.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measures cannot be used to advantage.

Any reference signs in the claims should not be construed as limiting the scope.

1. Driver device for driving a load, in particular a light unit comprising one or more LED's, comprising:
input terminals for connecting the driver device to an external electrical power supply and for receiving an input voltage,
a power converter unit connected to the input terminals for converting the input voltage to a drive voltage and/or a drive current for powering the load,
a control unit connected to the power converter unit for controlling an electrical power provided by the power converter unit to the load,
an input device connected to the control unit for setting a power level of the electrical power provided by the power converter unit to the load, and
a memory device comprised in the control unit, characterized in that the control unit is adapted to determine a minimum power level of the electrical power that can be drawn from the input terminals and to store the determined level of the electrical power in the memory device, and wherein the control unit is adapted to control that the electrical power which is drawn from the external electrical power supply does not drop below the minimum power level.

2. (canceled)

3. Driver device as claimed in claim 1, wherein the control unit is adapted to control the power converter unit so that the electrical power drawn from the input terminals is decreased in order to determine the minimum power level.

4. Driver device as claimed in claim 3, wherein the control unit is adapted to decrease the power level continuously.

5. Driver device as claimed in claim 3, wherein the control unit is adapted to decrease the power level stepwise.

6. Driver device as claimed in claim 1, wherein the control unit is connected to the input terminals in order to receive electrical power from the input terminals.

7. Driver device as claimed in claim 1, wherein the control unit is adapted to determine the level of the electrical power during the operation of the driver device on a regular basis.

8. Driver device as claimed in claim 1, wherein the memory device is a non-volatile memory.

9. Driver device as claimed in claim 1, wherein the control unit is adapted to control the power converter unit on the basis of an input signal received from the input device and on the basis of the level of the electrical power stored in the memory device.

10. Driving method for driving a load, in particular a lighting device comprising one or more LEDs, comprising the steps of:
receiving an input voltage from an external electrical power supply at input terminals,
converting the input voltage by means of a power converter unit to a drive voltage and/or a drive current for powering the load,
controlling an electrical power level provided by the power converter unit to the load,
determining a minimum power level of the electrical power that can be drawn from the input terminals, and
storing the determined level of the electrical power in a memory device
controlling that the electrical power which is drawn from the external electrical power supply does not drop below the minimum power level.

11. Driving method as claimed in claim 10 wherein repeatedly a level of the electrical power drawn from the input terminals is stored in the memory device followed by a reduction of the level of the electrical power to determine the minimum power level as the level of the electrical power.

12. Driving method as claimed in claim 11, wherein the level of the electrical power is reduced until the electrical power drawn from the input terminals is turned off.

13. Driving method as claimed in claim 10 wherein the power level is decreased continuously or stepwise.

14. Driving method as claimed in claim 10, wherein the level of the electrical power is determined during the operation on a regular basis.

15. Lighting apparatus comprising a light unit having one or more LEDs, a driver unit for providing electrical power wherein the driver unit is adapted to drive a lighting device, and a driver device as claimed in claim 1 for driving the light unit, connected to the driver unit for receiving electrical power.

16. Lighting apparatus of claim 15, wherein the driver unit is adapted to drive a fluorescent tube lamp or a high intensity discharge lamp.
